(19) United States
(12) Patent Application Publication
(10) Pub. No.: US 2005/0288017 A1
(43) Pub. Date: Dec. 29, 2005

(54) Method and system for calculating the 2G-3G neighborhood for an automatic transfer of connection between 2G and 3G systems

(76) Inventors: Didier Doumenc, Chatillon (FR); Imad Fattouch, Paris (FR); Soudabeh Serre, Carrieres Sur Seine (FR); Fracois Vincent, Clamart (FR)

Correspondence Address: PERMAN & GREEN, 425 POST ROAD, FAIRFIELD, CT, 06824, US

(21) Appl. No.: 11/148,014

(22) Filed: Jun. 8, 2005

(30) Foreign Application Priority Data
Jun. 22, 2004 (FR) 04 06753

(51) Int. Cl. H04Q 7/20

(52) U.S. Cl. 455/435.3; 455/436; 455/432.1

(57) ABSTRACT

The method for transfer between systems of different generation includes: modeling with cutting-out of the network into radio cells by distinguishing the frequency bands used, hierachization using coverage data for producing in tables (T) for each frequency band, best/second best server cell data, respectively, representative of an index listing zones corresponding to the best/second best coverage level,

determining the zone of radio cells and the source frequency band used in a first system by the terminal, followed by selecting a corresponding starting cell (21, 22) in the tables, generating from the tables a list of candidate cells belonging to a second system and neighbors of the starting cell, selecting in the list at least one arrival cell according to selection criteria.

The present invention relates to cellular radiotelephone networks, and more specifically, for the purpose of improving radio coverage in a network managed by an operator, to a method and system for calculating the 2G-3G neighborhood in order to provide automatic transfer of connection between 2G (for example GSM, GPRS, CDMA, etc.) and 3G (UMTS) systems.

A cellular radiotelephone network consists of a plurality of radioelectric base terrestrial stations provided with transceivers which provide radio coverage of zones defining respective cells. A very widespread cellular radiotelephone communications system today is the CDMA (code division multiple access) system. The use of spectrum-spreading CDMA techniques may provide high rates for mobile terminals. The most recent CDMA standard (for example, Wide Band CDMA: W-CDMA), a so-called third generation (3G) standard, is thus in the deployment phase for many operators. Consequently, the mobile terminals are needed to be more compatible with both the old second generation systems (2G) and the new 3G systems.

In a typical cellular radiotelephone network, a mobile terminal may communicate with the base station having the strongest available signal. In order to track the available signals, the mobile terminal has a permanently updated list of available base stations. Generally, each base station of the system transmits signals so that the mobile terminal may determine the station with the strongest signal. This determination is authorized by a module for managing radio resources of the mobile terminal, having means for detecting and measuring the intensity of the signals.

The results of the module for managing the radio resources are transmitted to the active base station, which gives back instructions to the mobile terminal in order to update the list of available base stations. As soon as the mobile terminal moves away from a cell, the latter must access a new base station, notably determined from the list of the available base stations. The transfer or handover must be achieved before the connection is interrupted with the old base station in order to provide continuity of the communication and to attain complete transparency for the user. In the case of softer handover for which the mobile terminal is found in a coverage zone common to two adjacent sectors of a same base station, the transfer is achieved by selecting a different transceiver of the base station. In any case, communications between the different transceivers and the mobile terminal simultaneously take two radio channels. Therefore, this is a type of handover which retains the frequency. There also are hard handovers which are of the inter-frequency type (enabling a mobile phone to pass from one W-CDMA frequency to another, for example) or of the inter-system type (enabling a mobile telephone to pass from one system to another such as from W-CDMA to GSM, for example).

In most present cellular radiotelephone communications systems, the handover cannot properly occur between systems of different generations. Insofar as the systems use different modulation patterns and propagation velocities, they naturally are not compatible at the level of the physical layer. This represents a problem for the user of a 3G system including coverage holes, which may be filled by resorting to an already installed 2G system. Therefore it seems to be desirable to allow the transition from one network coverage to the other, in each of the 2G and 3G systems, without encountering inconveniences from interruptions during the handover.

In the prior art, from document U.S. Pat. No. 6,567,666, a handover method is known between CDMA systems of different generations, in which the active base station receives from the mobile terminal, measurements of the strength of each of the pilot signals listed in a list including the pilot signals of the neighboring base stations, and then transmits to the mobile terminal, a message providing the selection of any of the received pilot signals with a level larger than a defined threshold on the one hand, and on the other hand parameter and configuration data allowing the mobile terminal to be configured before triggering a handover.

A drawback of this type of methods is that no feature other than the field level is taken into account for selecting the base station to which one switches. In other words, it is not possible to optimize the use of the network. Further, forming a hierarchy of the different layers is not allowed, such as for example among the types of frequencies of GSM, with the frequency band at 900 MHz, the frequency band at 1,800 MHz and the additional frequency band provided for the microcells. Therefore there is a need to find a method more suited to the reality in the field, allowing efficient configuration of the network in order to achieve a handover towards the best server cell.

The first object of the present invention is therefore to suppress one or more of the drawbacks of the prior art by defining a method for calculating the 2G-3G neighborhood with which, by taking into account coverage, traffic and service quality data, it is possible to provide an adequate and efficient solution for parameterizing the automatic transfer of connection between 2G and 3G systems.

Another object of the invention within the scope of 2G-3G neighborhood calculation is to enable available frequency bands to be hierarchized to promote switching towards priority frequencies.

For this purpose, the invention relates to a method for calculating the 2G-3G neighborhood in order to provide parameterization of an automatic transfer of connection between systems of different generation when a bimodal mobile radio terminal moves between such systems, applied in a cellular radiotelephone network by computer equipment, comprising a preliminary modeling step including the cutting-out of the network into a plurality of radio cells generated by transmitting/receiving means of base stations of the network, the cutting-out distinguishing the frequency bands used in each of the cells, the computer equipment storing in storage means, coverage data at any point of the network, characterized in that it includes a so-called hierarchization step using the coverage data for producing, in hierarchy tables, for each frequency band within the cut-out network, best server cell and at least second best server cell data, respectively, representative of an index listing zones of radio cells corresponding to the best coverage level, to the second best coverage level, respectively, the method further comprising:

a configuration step comprising the storage of calculation parameters in a configuration file,

a step for determining the zone of radio cells and the source frequency hand used in a first system by the bimodal mobile radio terminal, followed by a step for selecting in the hierarchy tables, at least one starting cell corresponding to this zone and to the determined source frequency band,

a step for generating from hierarchy tables, a list of so-called candidate cells belonging to a second system and neighbors of said starting cell,

a step for selecting in the list of candidates, at least one arrival cell according to at least one selection criterion.

According to another feature, the step for generating the list of candidate cells comprises a step for calculating, for each of the neighboring cells of the second system, the surface of overlap with the starting cell and a step for weighting the overlapping surface according to geomarketing data associated with the relevant neighboring cell.

According to another feature, the step for generating the list of candidate cells comprises a step for discriminating neighboring cells of the second system having a percentage of overlap with the starting cell, less than a percentage threshold parameterized during the configuration step.

According to another feature, the hierarchization step comprises, for each frequency band, a step for creating a first digital map of best server cells, and a second digital map of second best server cells, said first and second maps comprising a cut-out into distinct zones without any overlapping, so as to associate with any point of the network, a unique pair of best server cell and second best server cell per frequency band.

According to another feature, the step for selecting a starting cell begins by preselecting in the hierarchy tables, the best server cell, and at least the second best server cell corresponding to the determined source frequency band and to the zone where the terminal is located, and then results in selecting a starting cell only if the field level of a preselected cell exceeds a first predetermined threshold.

According to another feature, the step for selecting arrival cells comprises a step for validating candidate cells by comparing the field level of each of these candidates with a second predetermined threshold in order to achieve selection of an arrival cell only if the field level of one of the candidates exceeds said second threshold.

With the invention, it is thereby possible to select a cell with a sufficiently high field level in order to allow achievement of the inter-system handover, a second best server cell being able to be selected in the case of is a failure or uncertainty for the best server cell.

According to another feature, the modeling step includes a cutting-out distributing the cells of the cellular radiotelephone network among a first GSM type system with at least two different frequency bands and a second W-CDMA type system with at least one frequency band.

According to another feature, when said second system provides different frequency bands, a priority level defined during a step for defining priority, is associated with each of the frequency bands of this second system so as to be used as a selection criterion during said step for selecting candidate cells in the list.

According to another feature, the method according to the invention includes a first comparison step for comparing with a first maximum threshold with a predetermined offset, the field level difference between the best server cell and the second best server cell preselected during the step for selection in the hierarchy tables, whereby exceeding this first maximum threshold triggers a step for removing the second best server cell in order to select the best server cell as starting cell.

According to another feature, the method according to the invention includes a second comparison step concerning at least one frequency band of said second system for comparing with a second maximum threshold with a predetermined offset, the field level difference between the best server cell and the second best server cell extracted from the list of candidate cells, whereby exceeding this second maximum threshold corresponds to a criterion for non-selection triggering a step for removing the second best cell during the step for selecting arrival cells.

According to another feature, the step for generating the list of candidate cells is limited to a determined threshold number of candidate cells, parameterized during a second parameterization step.

According to another feature, the step for generating the list of candidate cells comprises a step for detecting cells belonging to the second system and stemming from the same transmitting/receiving site or sector as the starting cell.

According to another feature, the calculation step takes into account a minimum field level in order to define the overlapping surface of each of the neighboring cells, the step for weighting the overlapping surface taking into account a weighting coefficient representative of the type of overground and/or traffic density in the cell.

According to another feature, the step for selecting in the candidate list uses as a selection criterion, the distance between the site or sector generating the candidate cell and the position of the radio terminal.

According to another feature, the selected arrival cells are grouped together into a list of arrival cells comprising a determined classification according to selection criteria.

Hence, advantageously, with the invention, it is possible to send to the radio terminal, a limited list of neighboring cells selected beforehand according to relevant criteria such as the overlapping with the potential starting cells, or the distance from the terminal to the base station of a neighbor. Further, with the classification according to the selection criteria, a handover towards a priority frequency band may be promoted.

Another object of the invention is to provide a solution to one or more of the problems encountered in the prior art by defining computer equipment, specially adapted to the method according to the invention, for optimizing automatic transfer of connection between 2G and 3G systems.

This object is achieved by computer equipment for applying the method according to the invention, including storage means, calculation means and first selection means, said storage means including in a first memory, representative data of geographical zones covered by a cellular radiotelephone network, divided into a plurality of points or pixels, in a second memory, representative data of a cut-out of the network into a plurality of radio cells distributed among two systems of different generation, whereby the cutting-out distinguishes frequency bands used in each of the cells, and in a third memory, coverage data at any point of the network, said equipment being characterized in that it includes:

interactive means between the user and said equipment to allow input of calculation parameters, the storage means storing the calculation parameters in a configuration file,

means for extraction and tabulation from coverage data, in order to generate hierarchy tables transferring best server cell and at least second best server cell data for each frequency band within zones of radio cells of the cut-out network,

means for collecting information in order to determine the position in the network and the source frequency band of bimodal mobile radio terminals, the first selection means being laid out for using the frequency band and position data, collected by the information collecting means for a radio terminal in order to select in hierarchy tables at least one starting cell associated with this radio terminal in a first system and corresponding to said source frequency band,

a generation module available to the calculation means able to use the cut-out data and the hierarchy tables of the network in order to generate a list of so-called candidate cells belonging to a second system and neighbors of said starting cell, the calculation means comprising second selection means for selecting in the list of candidates at least one arrival cell according to at least one calculation parameter of the configuration file.

According to another feature, the generation module is laid out for extracting from hierarchy tables a preliminary list of cells of the second system, neighbors of said starting cell, and calculating the surface of overlap with the starting cell of each of these neighboring cells, the generation module being further capable of using geomarketing data stemming from coverage data for weighting the calculated overlapping surface.

According to another feature, the generation module has a comparison module of the calculation means, capable of discriminating neighboring cells of the second system having a percentage of overlap with the starting cell, less than a percentage threshold parameterized in the configuration file.

According to another feature, the first selection means have a comparison module of the calculation means in order to allow a starting cell to be selected for a determined frequency band only if the corresponding field level exceeds a first predetermined threshold parameterized in the configuration file.

According to another feature, the second selection means have a comparison module of the calculation means in order to validate candidate cells by comparing the field level of each of these candidates with a second predetermined threshold parameterized in the configuration file, the second selection means selecting an arrival cell only if the field level of one of the candidates exceeds said second threshold.

According to another feature, the network data stored in the storage means represent a cut-out distributing the cellular radiotelephone network cells among a first GSM type system with at least two different frequency bands and a second system of the W-CDMA type with at least one frequency band.

According to another feature, the second selection means are laid out in order to distinguish among the candidate cells, a priority level of a frequency band, the configuration file providing the storage of calculation parameters representative of a priority level for each of the frequency bands.

According to another feature, the first selection means are able to use position and frequency band data collected by the information-collecting means for preselecting the corresponding best and second best server cells and further have a comparison module of the calculation means for comparing with a first maximum threshold with a predetermined offset, parameterized in the configuration file, the field level difference between said best server cell and said second best server cell, the first selection means being laid out in order to only select as starting cell, the best server cell if the first maximum threshold is exceeded.

According to another feature, the second selection means have a comparison module of calculating means for discriminating among the candidate cells second best server cells by comparing the field level difference between the best server cell and the second best server cell of a same frequency band, with a second maximum threshold with a predetermined offset parameterized in the configuration file.

According to another feature, the configuration file includes a parameter for limiting to a threshold number determined from the list of candidate cells, the generation module using this limitation parameter for providing a list having the determined number of candidate cells.

According to another feature, the configuration file includes a parameter for selecting co-site or co-sector cells relatively to said starting cell, the generation module being laid out in order to insert into the list of candidate cells, cells belonging to the second system and stemming from the same transmitting/receiving site or sector as the starting cell.

According to another feature, the generation module is laid out in order to take into account a minimum field level parameterized in the configuration file during calculation of the overlapping surfaces on the one hand and on the other hand of a weighting coefficient parameterized in the configuration file and representative of the type of overground and/or the traffic density in the cell, in order to multiply the overlapping surface by the weighting coefficient.

According to another feature, the configuration file includes a selection parameter relative to the distance between the site or sector generating the candidate cell and the position of the radio terminal.

According to another feature, the calculation means are laid out in order to classify in a determined way the arrival cells according to parameters of the configuration file.

The invention, with its features and advantages will become more apparent upon reading the description made with reference to the appended drawings given as non-limiting examples, wherein:

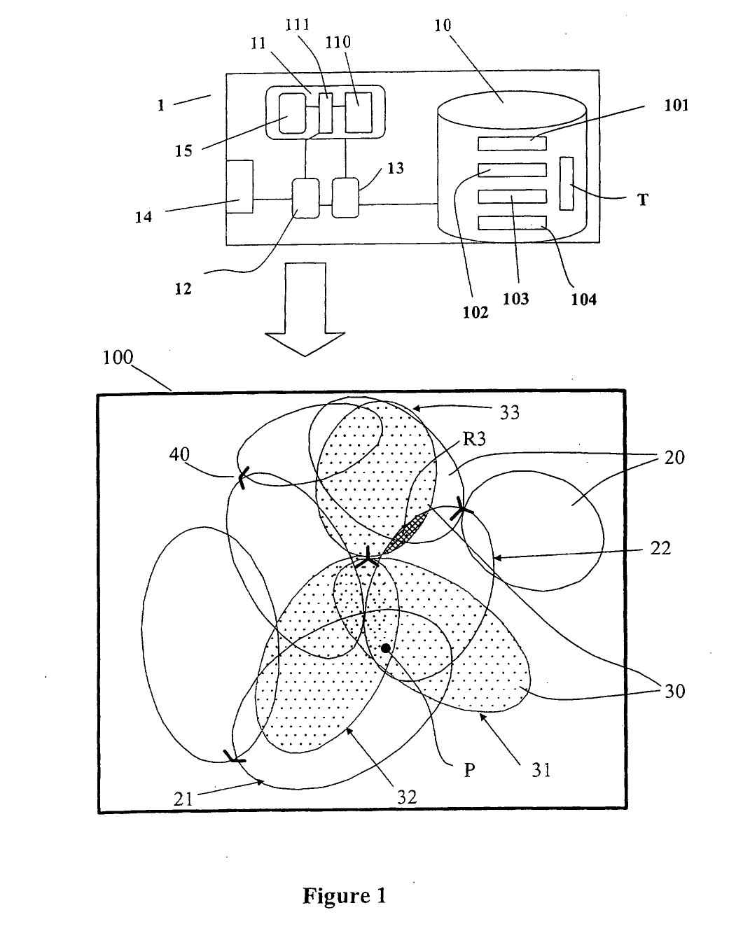

FIG. 1 schematically illustrates the computer equipment according to the invention and a map illustrating the overlapping between cells of systems of different generation,

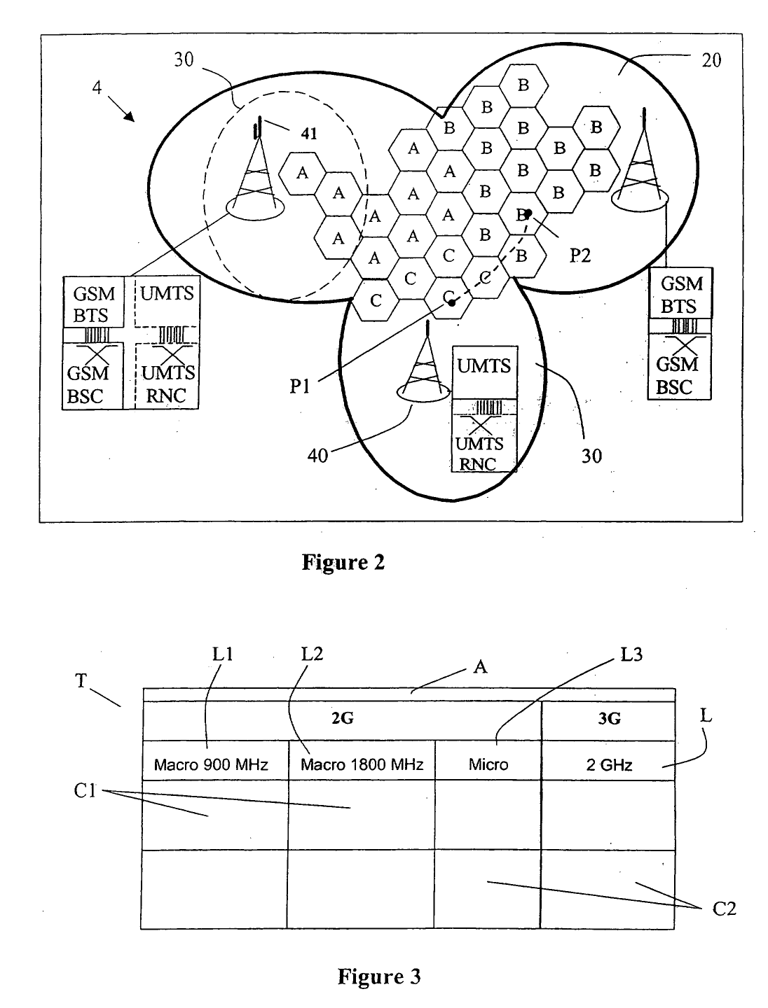

FIG. 2 shows an example of a situation requiring an handover according to the teaching of the present invention,

FIG. 3 illustrates a hierarchy table transferring for each frequency band the best and second best server cell for a defined zone of radio cells of the network,

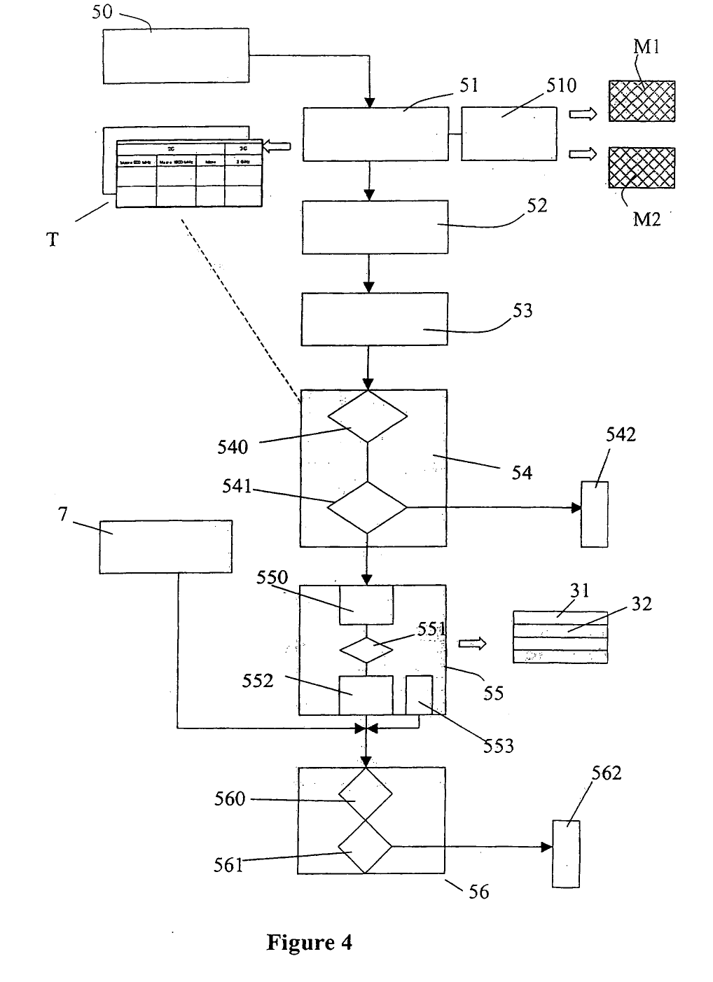

FIG. 4 illustrates a logic diagram of the steps of the method in one embodiment of the invention,

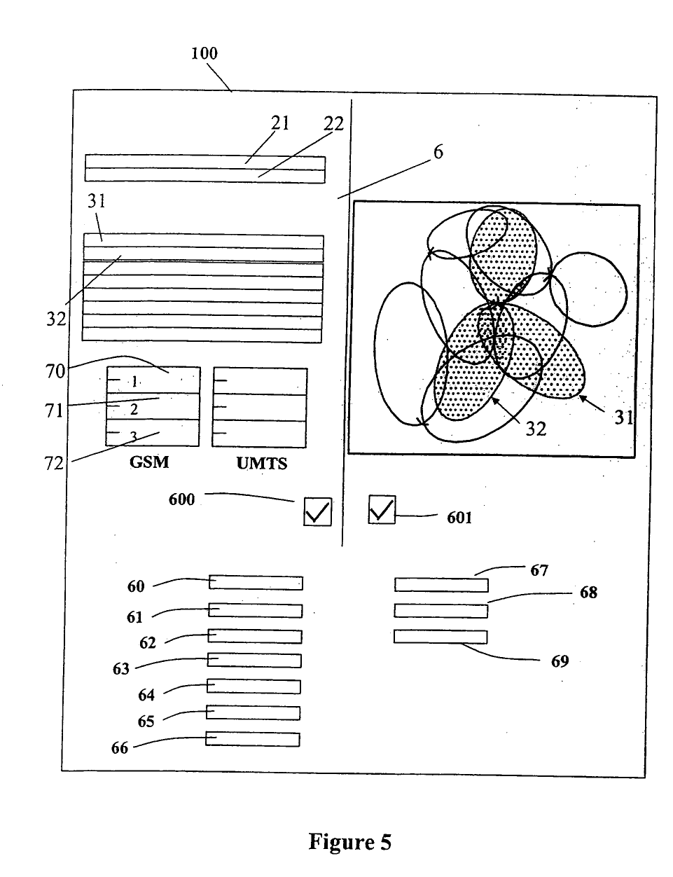

FIG. 5 illustrates a window allowing input and selection of calculation parameters.

The invention will now be described with reference to FIGS. 1, 2 and 3.

The computer equipment (1) according to the invention is intended for calculating the 2G-3G neighborhood in order to allow parameterization of an automatic transfer of connection between systems of different generation when a bimodal mobile radio terminal moves between such systems in a cellular radio telephone network (4). The equipment (1) shown in FIG. 1 includes storage means (10), calculation means (11) and first selection means (12). The storage means (10) may consist of a first memory (101) for storing data representative of geographical zones covered by a cellular radiotelephone network (4) and divided into a plurality of points or pixels, of a second memory (102) for storing data representative of a cut-out of the network into a plurality of radio cells (20, 30) and of a third memory (103) for storing coverage data at any point of the network (4).

The achieved cut-out distinguishes two systems of different generation used by each of the radio cells (20, 30). These cells are generated by transmitting/receiving means (41) of base stations (40) of the network (4). In a preferred embodiment of the invention, the cutout distinguishes the different frequency bands for each of the radio cells (20, 30), several frequency bands may be provided for one system. This cut-out may correspond to a modeling of the network (4) distributing the cells (20, 30) of the cellular radiotelephone network (4) among a first second generation system, for example, and in a non-limiting way of the GSM type with at least two different frequency bands, and a second third generation system for example of the W-CDMA type with at least one frequency band.

As illustrated in FIG. 1, interactive means (100) between the user and said equipment (1) are provided for inputting and displaying selectable calculation parameters, as well as for displaying maps of the network, such as for example coverage maps of the network (4) in a geographical zone for example with the size of a quarter, a town or a district. The processing or calculation means (11) or central unit, the storage means (10), as well as the means for input through a keyboard with a mouse or another device, or for showing data through an interactive display screen (100), have not been illustrated in detail. A configuration file (104) stored in the storage means (10) for example allows the calculation parameters to be grouped together. The equipment according to the invention is provided with extraction means (13) and tabulation means for generating, from coverage data, hierarchy tables (T) transferring best server cell (C1) and at least second best server cell (C2) data for each frequency band within zones of radio cells of the cut-out network (4). These hierarchy tables (T) are stored in the storage means (10).

In the example of FIG. 3, representative data of the best (C1) and the second best (C2 server cells are transferred into the hierarchy table corresponding to a defined zone (A) of radio cells of the network (4). In the embodiment of FIG. 3, the network (4) consists of radio cells (30) adapted for the 2 GHz (L) frequency band or layer of UMTS (Universal Mobile Telecommunication System) on the one hand, and on the other hand, of radio cells (20) defining macro-cells for the 900 MHz layer (L1), macro-cells for the 1,800 MHz layer (2), or even micro-cells for an extra-layer (L3), respectively, like in the example of the GSM second generation system. Any third generation system analogous to UMTS may also be used, such as for example CDMA-2000. The hierarchy tables (T) may be shown as an index corresponding to defined zones of radio cells (A) and designating the server cell (C1) having the best coverage level for each of the conceivable frequency bands in the network (4), the server cell (C2) having the best second coverage level respectively.

In an embodiment of the invention, for each frequency band, a digital map (M1) cutting out the zones (A) of best server cells (C1) may be created by the map generation means (not shown) of the computer equipment (1), from network data such as the coverage data. Likewise, a digital map (M2) cutting out zones of best second server cells (C2) may be created. It is even conceivable to create a map with the third best server cells in alternative embodiments. Such maps (M1, M2 are for example stored among coverage data in the third memory (103). For this type of map (M1, M2) it is understood that there is no overlapping, each best server cell (C1) having its own predominance zone distinct from any other cell for a given frequency band.

In the example of FIG. 1, the computer equipment (1) includes information (14) collecting means for determining the position in the network (4) and the source frequency band of bimodal mobile radio terminals. The displacements of a first point (P1) towards a second point (P2) in the network (4) may thereby be tracked. When the mobile radio terminal travels from one cell of a determined generation system towards a cell (20) of a system of another generation, for example from UMTS to GSM in the example of FIG. 2, an inter-system handover decision needs to be made in order to provide continuity of the service provided by the network (4). In an embodiment of the invention, the first selection means (12) allow the use of frequency band and position data collected by the means for collecting information (14) relative to a radio terminal, in order to select in the hierarchy tables (T) at least one starting cell (21, 22) associated with this radio terminal in a first system and corresponding to said source frequency band. With reference to FIG. 1, when a radio terminal using the cells (20) of the GSM system is located in position (P) and moves towards a zone covered by cells (30) of a second system of the UMTS type, the first selection means (12) will for example identify by means of the hierarchy tables (T) at least two starting cells (21, 22) in this first GSM system.

With reference to FIG. 3, with the computer equipment (1), it is possible to distinguish different layers (L, L1, L2, L3) or frequency bands within systems of the network (4). In an embodiment of the invention, network data (4) stored in the storage means (10) represent a cut-out distributing the cells (20, 30) of the cellular radiotelephone network (4) among a first GSM type system with at least two different frequency bans (L1, L2, L3) and a second W-CDMA type system with at least one frequency band (L). Hence, the hierarchy tables (T) like the digital maps (M1, M2) take into account each of the layers (L, L1, L2, L3), in order to take into account best server cells and second best server cells for each of the frequency bands which may be used by a bimodal mobile radio terminal.

These first selection means (12) may have a comparison module (111) of the calculation means (11) in order to allow selection of a starting cell (21, 22) for a determined frequency band of a first system, only if the corresponding field level exceeds a first predetermined threshold (61), parameterized in the configuration file (104). Such a starting cell (21, 22) is used subsequently as reference for determining neighboring cells (31, 32, 33) by using one or more frequency bands of a system of different generation.

With reference to FIG. 1, the computer equipment (1) is further provided with a generation module (110) available to the calculation means (11), allowing the use of cut-out data and hierarchy tables (T) of the network (4) for generating a list of so-called candidate cells (31, 32) belonging to the second system, i.e., to the UMTS system, in the case of the example of FIG. 1. The candidate cells (31, 32) are neighboring cells of said starting cell (21, 22). It is easily understood that for achieving and inter-system handover, the candidate cells (31, 32) are selected from the cells (30) of a system different from the one of the starting cells (20). A handover may also be achieved according to the invention from a 3G system to a 2G system and vice versa.

The invention will be now described with reference to FIGS. 1, 3 and 5.

The calculation means (11) of the equipment (1) comprise second selection means (15) for selecting in the list of candidates (21, 22) at least is one arrival cell according to at least one calculation parameter from the configuration file (104). In particular, with the computer equipment (1), it is possible to select via these second selection means (15), an arrival cell having a sufficiently high field level so as to allow achievement of the inter-system handover, a second best server cell (C2) may be selected in the case of failure or uncertainty for the best server cell (C1). For this, the second selection means (15) have a comparison module (111) of the calculation means (11) for validating candidate cells (31, 32) by comparing the field level of each of these candidates (31, 32) with a predetermined threshold (62) parameterized in the configuration file (104), the second selection means (15) selecting an arrival cell only if the field level of one of the candidates 931, 32) exceeds said threshold (62).

To maximally reduce the time for scanning frequencies to be searched for by the bimodal radio terminal during an inter-system handover, the computer equipment (1) firstly allows the number of neighboring cells (31, 32, 33) to be reduced to a reduced number of candidate cells (31, 32) and secondly by using calculation parameters, the number of candidate cells (31, 32) may be limited to a limited number of arrival cells.

In an embodiment of the invention, the generation module (110) is laid out for extracting from the hierarchy tables (T) a preliminary list of cells (31, 32, 33) of the second system, neighbors of said starting cell (21, 22) and for calculating the surface of overlap with the starting cell (21, 22) of each of these neighboring cells (31, 32, 33). This generation module (110) may use geomarketing data stemming from coverage data for weighting the calculated overlapping surface. The calculated overlapping surface may for example be artificially increased or reduced by multiplying this overlapping surface with a weighting coefficient. The generation module (110) is for example laid out in order to take into account, during the calculation of the overlapping surfaces, a minimum field level (66) parameterized in the configuration file (104), on the one hand, and on the other hand the weighting coefficient parameterized In the configuration file (104) and representative of the type of overground and/or traffic density in the cell. In the example of FIG. 5, a weighting option (600) may be selected on a parameterization window (6) displaced by the interactive means (100).

The generation module (110) may have a comparison module (111) of the calculation means (11) in order to discriminate among the neighboring cells (31, 32, 33) of the second system, the ones which have a percentage of overlap with the starting cell (21, 22) less than a percentage threshold (60) parameterized in the configuration file (104). In the example of FIG. 1, a neighboring cell (33) only covers the starting cells (21, 22) over a small surface (R3). As the percentage of overlap of this neighboring cell (33) relatively to the starting cell (22) being less than said percentage threshold (60), for example parameterized at a value of 5%, this cell (33) is discarded from the list of candidate cells (31, 32). The comparison may also be actually performed between true surfaces or between weighted surfaces.

In an embodiment of the invention, the weighting notably depends on the overground, so that the actual traffic distribution which varies according to the class of overground and possibly with the flow axis type may be taken into account. For example, this weighting is obtained from a file stored in the storage means (10) which is shown as a weighting matrix, as illustrated below.

| | No | | | | | Urban | Urban | Urban | Urban | Urban |
|---|---|---|---|---|---|---|---|---|---|---|
| Type of | informa- | | Mineral | Open | | <10 | <50 | <100 | <200 | <300 |
| overground | tion | Water | surface | space | Forest | inhab/km² | inhab/km² | inhab/km² | inhab/km² | inhab/km² |
| Overground class | 0 | 1 | 2 | 3 | 4 | 5 | 6 | 7 | 8 | 9 |
| Motorways | 0 | 10 | 10 | 10 | 10 | 20 | 20 | 20 | 20 | 20 |
| Highways | 0 | 4 | 4 | 4 | 4 | 10 | 10 | 10 | 16 | 16 |
| Railway tracks | 0 | 4 | 4 | 4 | 4 | 8 | 8 | 10 | 15 | 15 |
| Minor roads | 0 | 3 | 3 | 3 | 3 | 8 | 8 | 10 | 15 | 15 |
| Local roads | 0 | 2 | 2 | 2 | 2 | 8 | 8 | 10 | 15 | 15 |
| Main streets | 0 | 1 | 1 | 1 | 1 | 5 | 5 | 5 | 8 | 8 |
| Secondary streets | 0 | 1 | 1 | 1 | 1 | 5 | 5 | 5 | 8 | 8 |
| No axis | 0 | 1 | 1 | 1 | 1 | 5 | 5 | 5 | 8 | 8 |

| | Urban | Urban | Urban | Urban | Urban | Urban |
|---|---|---|---|---|---|---|
| Type of | <400 | <500 | <600 | <800 | <1,000 | <1,000 |
| overground | inhab/km² | inhab/km² | inhab/km² | inhab/km² | inhab/km² | inhab/km² |
| Overground class | 10 | 11 | 12 | 13 | 14 | 15 |
| Motorways | 20 | 25 | 25 | 25 | 25 | 25 |
| Highways | 16 | 16 | 20 | 20 | 20 | 20 |
| Railway tracks | 15 | 15 | 20 | 20 | 20 | 20 |
| Minor roads | 15 | 15 | 18 | 18 | 18 | 18 |
| Local roads | 15 | 15 | 18 | 18 | 18 | 18 |
| Main streets | 10 | 12 | 15 | 15 | 15 | 15 |
| Secondary streets | 10 | 12 | 15 | 15 | 15 | 15 |
| No axis | 10 | 10 | 10 | 10 | 10 | 10 |

With reference to FIG. 5, the parameterization window (6) displayed by the interactive means (100) allows the user to refine the selection of arrival cells (31, 32). In the preferred embodiment of the invention, the second selection means (15) are laid out in order to distinguish among the candidate cells (31, 32), a priority level (70, 71, 72) of a layer or frequency band. The configuration file (104) provides storage for calculation parameters representative of these priority levels (70, 71, 72) for each of the frequency bands. The calculation means (11) may classify in a determined way the arrival cells (31, 32) according to certain parameters from the configuration file (104) and notably from these priority levels (70, 71, 72).

To optimize selection of a starting cell (21, 22), it may be advantageous to not take into account second best server cells (C2) for which the field level is too low relatively to the best corresponding server cell (C1). Indeed, such a server cell (C2) will practically almost never be selected by the radio terminal. The field level difference between said best server cell (C1) and said second best server cell (C2) may therefore be used for discriminating the cells (C2) with a too low level. For this, the first selection means (12) are capable of using the frequency band and position data, collected by the information (14) collecting means so as to firstly preselect the corresponding best and second best server cells (C1, C2) and secondly compare this field level difference with a first maximal threshold (63) with a predetermined offset, parameterized in the configuration file (104). The comparison module (111) of the calculation means (11) is available to the first selection means (12) for the comparison. The field level difference for each zone (A) of the network (4) may be transferred into the hierarchy tables (T). The first selection means (12) are laid out so as to select as starting cell (21, 22), only the best server cell (C1) if this first maximum threshold (63) is exceeded.

Likewise, the comparison module (111) may be used by the second selection means (15) for discriminating among the candidate cells (31, 32) second best server cells (C2) by comparing the field level difference between the best server cell (C1) and the second best server cell (C2) of a same frequency band with a second maximum threshold (64) with a predetermined offset parameterized in the configuration file (104). As illustrated in FIG. 5, the configuration file (104) may include a limitation parameter for limiting the list of candidate cells (31, 32) to a determined threshold number (65). The generation module (110) for example uses this limitation parameter for providing a list having the determined number candidate cells (31, 32). Indeed, it may prove to be not very useful to search for a too large number of candidate cells (31, 32) in order to make an inter-system handover decision.

Moreover, the configuration file (104) may also include a parameter (601) for selecting co-site or co-sector cells relatively to the starting cell (21, 22). Actually it is useful to select in addition to the neighbors (31, 32, 33), cells which are generated from a same site by grouping GSM and UMTS base stations (40) together. Parameters such as the co-sector angle (67) or the co-site distance (68) may be taken into account to retain such cells. Hence, with the generation module (110), it is possible to insert into the list of candidate cells (31, 32) cells belonging to the second system and stemming from the same transmitting/receiving site or sector as the starting cell (21, 22). The case when the base station (4) allows both GSM system cells (20) and UMTS system cells (30) to be generated, is illustrated in the example of FIG. 2. The configuration file (104) also includes a selection parameter (69) relative to the distance between the site or sector generating the candidate cell (31, 32) and the position (P) of the radio terminal. This selection parameter (69) may be taken into account by the second selection means (15) for selecting one or several arrival cells.

The progress of the method according to the invention will now be described with reference to FIGS. 4 and 5.

The method according to the invention directed to calculating a 2G-3G neighborhood in order to allow parameterization of an automatic transfer of connection between systems of different generation, comprises a preliminary modeling step (50) including the cutting out of the network (4) per frequency bands so as to define a plurality of radio cells. As illustrated in FIG. 4, the method provides a hierarchization step (51) using network coverage data stored by the computer equipment (1) in order to produce in the hierarchy tables (T), for each frequency band, best server cell (C1) and at least second best server cell (C2) data. The hierarchization step (51) comprises for each frequency band, a step (510) for creating a first digital map (M1) of best server cells (C1) and a second digital map (M2) of second best server cells (C2), said first and second maps (M1, M2) comprising a cut-out into distinct zones (A) without any overlapping. Thus, the method allows any point of the network (4) to be associated with a unique best server cell (C1) and second best server cell (C2) pair, for a given frequency band.

A configuration step (52) is also provided for inputting or selecting calculation parameters from a configuration file (10). Before starting to calculate a neighborhood, a step (53) for determining the zone (A) of radio cells and the source frequency band used in a first system by the bimodal mobile radio terminal should be performed first. A step (54) follows for selecting in the hierarchy tables (T) at least one starting cell (21, 22) corresponding to this zone (A) and to the determined source frequency band. The step (54) for selecting a starting cell starts with preselecting in the hierarchy tables (T) the best server cell (C1) and at least the second best server cell (C2) corresponding to the determined source frequency band and to the zone (A) where the terminal is located. Selection of a starting cell is only achieved upon completion of an intermediate step (540) during which the field level of a preselected cell is compared with a first predetermined threshold (61). The selection of a starting cell (21, 22) may fail if no cell has a field level larger than this first threshold (61).

Further, a step (541) for comparison to a first maximum threshold (63) with a predetermined offset is achieved for the field level difference between the preselected best server cell (C1) and second best sever cell (C2). When this first maximum threshold (63) is exceeded, a step (542) is triggered for removing the second best server cell (C2) in order to select as starting cell (21, 22), the best server cell (C1).

The actual neighborhood calculation then starts with a step (55) for generating, from the hierarchy tables (T), the list of candidate cells (31, 32) belonging to a second system and neighbors of the selected starting cell(s) (21, 22). As illustrated in FIG. 4, the step (55) for generating the list of candidate cells (31, 32) comprises a step (550) for calculating for each of the neighboring cells (31, 32, 33) of the second system, the surface of overlap with the starting cell (21, 22). Said generation step (55) also includes a step (552) for weighting the overlapping surface according to geomarketing data associated with the relevant neighboring cell (31, 32, 33). Geomarketing data provide the influence of the type of overground and/or traffic density in the cell.

In an embodiment of the invention, the step (55) for generating the list of candidate cells (31, 32) further comprises a step (551) for discriminating neighboring cells (31, 32, 33) of the second system having a percentage of overlap with the starting cell (21, 22), less than the percentage threshold (60) parameterized during the configuration step (52). This step may be achieved after the step (550) for calculating the overlapping surfaces or in an alternative embodiment after the weighting step (552), the percentage threshold (60) being compared with the percentage of overlap of the weighted surface with the starting cell (21, 22). In an alternative embodiment, the step (55) for generating the list of candidate cells (31, 32) also comprises a step (553) for detecting cells belonging to the second system and stemming from the same transmitting/receiving site or sector as the starting cell (21, 22).

In the example of FIG. 4, when said second system provides different frequency bands, with a priority definition step (7), it is possible to take into account levels of priority (70, 71, 72) between frequency bands. A respective priority level (70, 71, 72) is associated with each of the frequency bands of this second system so as to be used as a selection criterion during a step (56) for selecting at least one arrival cell in the list of candidate cells (31, 32). One or more selection criteria are taken into account upon selecting arrival cells. The priority levels (70, 71, 72) may be inputted as parameters during the configuration step (52), the priority definition step (7) may correspond to a selection criterion triggering the taking into account of these priority levels (70, 71, 72) in order to classify the arrival cells in a determined order for example or to select an arrival cell associated with a priority frequency band.

In the embodiment of FIG. 4, the step (56) for selecting arrival cells, comprises a step (560) for validating candidate cells (31, 32) by comparing the field level of each of these candidates with a second predetermined threshold (62) to achieve selection of an arrival cell only if the field level of one of the candidates exceeds said second threshold (62). The step (56) for selecting arrival cells may also include a second comparison step (561) relative to at least one frequency band of said second system, for comparing with a second maximum threshold (64) with a predetermined offset, the field level difference between the best server cell (C1) and the second best server cell (C2) extracted from the list of candidate cells (31, 32). Exceeding this second maximum threshold (64) corresponds to a non-selection criterion triggering a step (562) for removing this second best cell (C2).

One of the advantages of the invention is to provide an optimized solution to the problems of coverage holes in third generation systems. The invention gives the possibility of achieving without any interruption a transfer from a 3G portion to a 2G portion of a network, taking into account the different existing layers (3 layers in the case of the GSM system).

The invention provides a tool for assisting with the parameterization for inter-system handover, taking into account relevant weightings on the quality of radio cells. The invention thus aims at satisfying coverage needs of a network during deployment of the third generation system.

It should be obvious for those skilled in the art that the present invention allows embodiments in many other specific forms without departing from the field of application of the invention as claimed. Accordingly, these present embodiments should be considered as an illustration, but they may be changed within the field defined by the scope of the appended claims, and the invention should not be limited to the details given above.

1. A method for calculating the 2G-3G neighborhood to allow parameterization of an automatic transfer of connection between systems of different generation when a bimodal mobile radio terminal moves between such systems, applied in a cellular radiotelephone network by a computer equipment (1), comprising a preliminary modeling step (50) including the cutting-out of the network (4) into a plurality of radio cells generated by transmitted/receiving means (41) of base stations (40) of the network (4), the cutting-out distinguishing frequency bands used in each of the cells, the computer equipment (1) storing in storage means (10) coverage data at any point of the network, characterized in that it includes a so-called hierarchization step (51) using the coverage data for producing in hierarchy tables (T), for each frequency band within the cutout network (4), best server cell (C1) and at least second best server cell (C2) data, respectively, representative of an index listing zones (A) of radio cells corresponding to the best coverage level, to the second best coverage level respectively, the method further comprising:
a configuration step (52) comprising storing in a configuration file (104) calculation parameters,
a step (53) for determining the zone (A) of radio cells and the source frequency band used in a first system by the bimodal mobile radio terminal, followed by a step (54) for selecting in the hierarchy tables (T), at least one starting cell corresponding to this zone (A) and to the determined source frequency band,
a step (55) for generating from the hierarchy tables a list of so-called candidate cells belonging to a second system and neighbors of said starting cell (21, 22),
a step (56) for selecting in the list of candidates, at least one arrival cell according to at least one selection criterion.

2. The method according to claim 1, wherein the step (55) for generating the list of candidate cells (31, 32) comprises a step (550) for calculating, for each of the neighboring cells (31, 32, 33) of the second system, the surface of overlap with the starting cell (21, 22) and a step (552) for weighting the overlapping surface according to geomarketing data associated with the relevant neighboring cell (31, 32, 33).

3. The method according to claim 1, wherein the step (55) for generating the list of candidate cells (31, 32) comprises a step (551) for discriminating neighboring cells (31, 32, 33) of the second system with a percentage of overlap with the starting cell (21, 22), less than a percentage threshold (60) parameterized during the configuration step (52).

4. The method according to claim 1, wherein the hierarchization step (51) comprises, for each frequency band a step (510) for creating a first digital map (M1) of best server cells (C1) and a second digital map (M2) of second best server cells (C2), said first and second maps (M1, M2) comprising a cut-out into distinct zones (A) without any overlapping, in order to associate with any point of the network (4), a unique best server cell (C1) and second best server cell (C2) pair per frequency band.

5. The method according to claims 1, wherein the step (54) for selecting a starting cell starts with preselecting in the hierarchy tables (T), the best server cell (C1) and at least the second best server cell (C2) corresponding to the determined source frequency band and to the zone (A) where the terminal is located, and then results in selecting a starting cell (21, 22) only if the field level of a preselected cell exceeds a first predetermined threshold (61).

6. The method according to claim 1, wherein the step (56) for selecting arrival cells comprises a step (560) for validating candidate cells (31, 32) by comparing the field level of each of these candidates with a second predetermined threshold (62) to achieve selection of an arrival cell only if the field level of one of the candidates (31, 32) exceeds said second threshold (62).

7. The method according to claim 1, wherein the modelling step (50) includes a cutting-out, distributing the cells of the cellular radiotelephone network among a first GSM type system with at least two different frequency bands and a second W-CDMA type system with at least one frequency band.

8. The method according to claim 1, characterized in, that said second system provides different frequency bands, a priority level (70, 71, 72) defined during a priority definition step (550) is associated with each of the frequency bands of this second system so as to be used as selection criterion during said step (56) for selecting candidate cells (31, 32) in the list.

9. The method according to claims 5, characterized in that it includes a first comparison step (541) for comparing with a first maximum threshold (63) with a predetermined offset, the field level difference between the best server cell (C1) and the second best server cell (C2) preselected during the step (54) for selection in the hierarchy tables, whereby if this first maximum threshold (63) is exceeded, a step (542) is triggered for removing the second best server cell (C2), in order to select as starting cell (21, 22), the best server cell (C1).

10. The method according to claim 1, characterized in that it includes a second comparison step (561) concerning at least one frequency band of said second system for comparing with a second maximum threshold (64) with a predetermined offset, the field level difference between the best server cell (C1) and second best server cell (C2) extracted from the list of candidate cells (31, 32) whereby if this second maximum threshold (64) corresponding to a non-selection criterion is exceeded, a step (562) is triggered for removing this second best cell (C2) during the step (56) for selecting arrival cells.

11. The method according to claim 3, wherein the step (55) for generating the list of candidate cells (31, 32) is limited to a determined threshold number (65) of candidate cells (31, 32), parameterized during a second parameterization step (502).

12. The method according to claim 1, wherein the step (55) for generating the list of candidate cells (31, 32) comprises a step (553) for detecting cells belonging to the second system and stemming from the same transmitting/receiving site or sector as the starting cell (21, 22).

13. The method according to claim 2, wherein the calculation step (550) takes into account a minimum field level (66) for defining the overlapping surface of each of the neighboring cells (31, 32, 33) the step (552) for weighting the overlapping surface taking into account a weighting coefficient representative of the type of overground and/or traffic density in the cell.

14. The method according to claim 1, wherein the step (56) for selecting in the list of candidates (31, 32) uses as a selection criterion the distance between the site or sector generating the candidate cell and the position of the radio terminal.

15. The method according to claim 1, wherein the selected arrival cells are grouped together in a list of arrival cells comprising a determined classification according to the selection criteria.

16. A computer equipment (1) for applying the method according to claim 1, including storage means (10), calculation means (11) and first selection means (12), said storage means (10) including in a first memory (101), data representative of geographical zones covered by a cellular radiotelephone network (4) divided into a plurality of points or pixels, in a second memory (102), data representative of a cut-out of the network (4) into a plurality of radio cells (20, 30) distributed among two systems of different generation, the cutting-out distinguishing frequency bands used in each of the cells (20, 30), and in a third memory (103) coverage data at any point of the network (4), said equipment (1) being characterized in that it includes:
interactive means (100) between the user and said equipment (1) allowing input of calculation parameters, the storage means (10) storing calculation parameters in a configuration file (104),
means for extraction (13) and tabulation from coverage data, for generating hierarchy tables (T) transferring best server cell and at least second best server cell data for each frequency band within zones of radio cells of the cut-out network (4),
means for collecting information (14) in order to determine the position in the network and the source frequency band of bimodal mobile radio terminals, the first selection means (12) being laid out in order to use the frequency band and position data, collected by the information collecting means (14) for a radio terminal in order to select in hierarchy tables (T) at least one starting cell (21, 22) associated with this radio terminal in a first system and corresponding to said source frequency band,
a generation module (110) available to the calculation means (11), capable of using the cut-out data and the hierarchy tables (T) of the network to generate a list of so-called candidate cells (31, 32) belonging to a second system and neighbors of said starting cell (21, 22), the calculation means (11) comprising second selection means (15) for selecting in the list of candidates (31, 32) at least one arrival cell according to at least one calculation parameter of the configuration file.

17. The equipment according to claim 16, wherein the generation module (110) is laid out for extracting from hierarchy tables (T) a preliminary list of cells (31, 32, 33) of the second system neighbors of said starting cell and calculating the surface of overlap with the starting cell of each of these neighboring cells, the generation module (110) being further capable of using geomarketing data stemming from coverage data for weighting the calculated overlapping surface.

18. The equipment according to claim 16, wherein the generation module (110) has a comparison module (111) of the calculation means (11) allowing discrimination of neighboring cells of the second system with a percentage of overlap with the starting cell, less than a percentage threshold (60) parameterized in the configuration file (104).

19. The equipment according to claim 16, wherein the first selection means (12) have a comparison module (111) of the calculation means (11) for allowing selection of a starting cell (21, 22) for a determined frequency band only if the corresponding field level exceeds a first predetermined threshold (61) parameterized in the configuration file (104).

20. The equipment according to claim 16, wherein the second selection means (15) have a comparison module (111) of the calculation means (11) for validating candidate cells by comparing the field level of each of these candidates with a second predetermined threshold (62) parameterized in the configuration file (104), the second selection means (15) selecting an arrival cell only if the field level of one of the candidates exceeds said second threshold (62).

21. The equipment according to claim 16, wherein the network data (4) stored in the memorization means (10) represent a cut-out distributing the cells of the cellular radiotelephone network (4) among a first GSM type system with at least two different frequency bands and a W-CDMA type system with at least one frequency band.

22. The equipment according to claim 16, wherein the second selection means (15) are laid out in order to distinguish among candidate cells, a priority level of a frequency band, the configuration file (104) providing storage for calculation parameters representative of a priority level (70, 71, 72) for each of the frequency bands.

23. The equipment according to claim 16, wherein the first selection means (12) are capable of using frequency band and position data collected by the information (14) collecting means for preselecting in correspondent best and second best server cells and further have a comparison module (111) of the calculation means (11) for comparing with a first maximum threshold (63) with a predetermined offset, parameterized in the configuration file (104), the field level difference between said best server cell (C1) and said second best server cell (C2), the first selection means (12) being laid out in order to select as starting cell (21, 22), only the best server cell (C1) if this first maximum threshold (63) is exceeded.

24. The equipment according to claim 16, wherein the second selection means (15) have a comparison module (111) of the calculation means (11) for discriminating among the candidate cells second best server cells (C2) by comparing the field level difference between the best server cell (C1) and the second best server cell (C2) of a same frequency band with a second maximum threshold (64) with a predetermined offset, parameterized in the configuration file (104).

25. The equipment according to claim 16, wherein the configuration file (104) includes a parameter for limiting to a threshold number (65) determined from the list of candidate cells (31, 32), the generation module (110) using this limitation parameter for providing a list with the determined number of candidate cells.

26. The equipment according to claim 16, wherein the configuration file (104) includes a parameter for selecting co-site or co-sector cells relatively to said starting cell, the generation module (110) being laid out in order to insert into the list of candidate cells, cells belonging to the second system and stemming from the same transmitting/receiving site or sector as the starting cell.

27. The equipment according to claim 16, wherein the generation module (110) is laid out for taking into account a minimum field level parameterized in the configuration file (104) during the calculation of the overlapping surfaces on the one hand, and on the other hand, a weighting coefficient parameterized in the configuration file (104) and representative of the type of overground and/or traffic density in the cell, for multiplying the overlapping surface by the weighting coefficient.

28. The equipment according to claim 16, wherein the configuration file (104) includes a selection parameter relative to the distance between the site or sector generating the candidate cell and the position of radio terminal.

29. The equipment according to claim 16, wherein the calculation means (11) are laid out for classifying in a determined way the arrival cells according to parameters of the configuration file.
